(19) United States
(12) Patent Application Publication
(10) Pub. No.: US 2015/0295654 A1
(43) Pub. Date: Oct. 15, 2015

(54) SYSTEM ARCHITECTURE FOR GLOBAL OPTIMIZATION OF FLEXIBLE GRID OPTICAL NETWORK AND GLOBAL OPTIMIZATION METHOD THEREFOR

(71) Applicant: BEIJING UNIVERSITY OF POSTS AND TELECOMMUNICATIONS, Beijing (CN)

(72) Inventors: Shanguo HUANG, Beijing (CN); Jingran LUO, Beijing (CN); Xin LI, Beijing (CN); Shan YIN, Beijing (CN); Weiguo JU, Beijing (CN); Min ZHANG, Beijing (CN); Jie ZHANG, Beijing (CN)

(73) Assignee: BEIJING UNIVERSITY OF POSTS AND TELECOMMUNICATIONS, Beijing (CN)

(21) Appl. No.: 14/420,850

(22) PCT Filed: Aug. 12, 2013
(86) PCT No.: PCT/CN2013/081280

§ 371 Date: Feb. 10, 2015

(30) Foreign Application Priority Data
Aug. 10, 2012 (CN) 201210285190.7

(51) Int. Cl. H04B 10/27

(52) U.S. Cl. CPC H04B 10/27

(57) ABSTRACT

The present invention discloses a system architecture for global optimization of a flexible grid optical network and a global optimization method therefor. The system architecture for global optimization of the flexible grid optical network provided in the present invention comprises a requesting unit for global optimization and an execution unit for global optimization, wherein the requesting unit for global optimization generates a request message for global optimization, and sends the request message for global optimization to the execution unit for global optimization; and the execution unit for global optimization parses the request message for global optimization, performs global optimization based on a constraint condition for global optimization, a computation algorithm for global optimization and a network topology and resource information of the flexible grid optical network, and returns a global optimization result to the requesting unit for global optimization.

### FIELD OF THE INVENTION

The present invention relates to a flexible grid optical network, particularly to a system architecture for global optimization of a flexible grid optical network and a global optimization method therefor.

### BACKGROUND OF THE INVENTION

Internet video service currently occupies 40% of user's network traffic. Moreover, its demand for traffic is increasing exponentially and approaching to the limit of SMF (single mode fiber) capacity. In order to further improve the spectrum utilization ratio and transmission capacity of optical fiber, an elastic optical network with Orthogonal Frequency Division Multiplexing (OFDM) technology-based spectrum flexible grid becomes a research hotspot of optical network at present. Flexible grid optical network removes the constraint of conventional fixed-frequency grid in International Telecommunication Union-Telecommunication Standardization Sector (ITU-T) and can realize free and efficient allocation of center frequency and bandwidth of an optical channel, so it effectively obtains the problem of efficient utilization of spectrum resources.

The global optimization of a flexible grid optical network mainly includes green space planning and defragmentation. The main objective of the green space planning process is to calculate the quantity of needed network resources under precondition of specific network topology in order to transmit given business demands. It involves a constraint condition, and the ultimate goal is to achieve optimization of the objective function. Green space planning is conducted for the flexible grid optical network and the network is optimized and configured under the condition of known network topology and network resource information to improve network resource utilization ratio under known traffic volume. In addition to green space planning technology, defragmentation technology is also a kind of global optimization. In the flexible grid optical network, the bandwidth of the optical channel is allocated based on traffic granularity, so there are traffic with different thread rate in the network. Every time the network administrator creates, resets or deletes an optical path, corresponding idle spectrum fragments will be generated or eliminated in the spectrum. These idle spectrum fragments are also called fragments. In the end, these fragments will be unevenly distributed everywhere, making the elastic grid optical network have to spend more time and resource in finding these fragments and forming a complete optical path. However, the existing Generalized Multiprotocol Label Switching (GMPLS) protocol stacks still don't have a special module which can carry out efficient global optimization of a flexible grid optical network.

### SUMMARY OF THE INVENTION

The present invention provides a system architecture for global optimization of a flexible grid optical network and a global optimization method therefor, which can overcome the foregoing defects of the prior art.

The present invention provides a system architecture for global optimization of a flexible grid optical network. The system architecture comprises a requesting unit for global optimization and an execution unit for global optimization, wherein:

the requesting unit for global optimization generates a request message for global optimization, and sends the request message for global optimization to the execution unit for global optimization;

the execution unit for global optimization parses the request message for global optimization, performs global optimization based on a constraint condition for global optimization, a computation algorithm for global optimization and a network topology and resource information of the flexible grid optical network, and returns a global optimization result to the requesting unit for global optimization.

the present invention also provides a method for global optimization of a flexible grid optical network. The method includes:

receiving and parsing a request message for global optimization;

performing global optimization based on a constraint condition for global optimization, a computation algorithm for global optimization and a network topology and resource information of the flexible grid optical network, and

sending a global optimization result.

In the system architecture for global optimization of a flexible grid optical network and a global optimization method therefor according to the present invention, after receiving a request message for global optimization from the requesting unit for global optimization, the execution unit for global optimization can perform global optimization based on a constraint condition for global optimization, a computation algorithm for global optimization and a network topology and resource information of the flexible grid optical network to achieve the goal of optimized use of network spectrum resources, thus improving resource utilization of the flexible grid optical network.

### BRIEF DESCRIPTION OF THE DRAWINGS

FIG. 1 is a system architecture for global optimization of a flexible grid optical network according to an embodiment of the present invention; and

FIG. 2 is a flow chart of a method for global optimization of a flexible grid optical network according to an embodiment of the present invention.

### EMBODIMENTS

Below the system architecture for global optimization of a flexible grid optical network and a global optimization method therefor according to the present invention are detailed referring to the accompanying drawings.

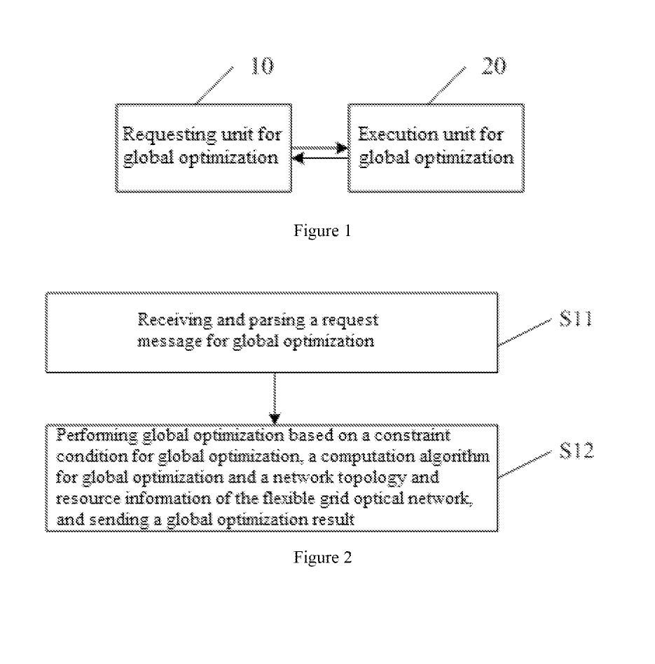

As shown in FIG. 1, the system architecture for global optimization of a flexible grid optical network according to the present invention comprises a requesting unit for global optimization 10 and an execution unit for global optimization 20, wherein: the requesting unit for global optimization 10 generates a request message for global optimization, and sends the request message for global optimization to the execution unit for global optimization 20; the execution unit for global optimization 20 parses the request message for global optimization, performs global optimization based on a constraint condition for global optimization, a computation algorithm for global optimization and a network topology and resource information of the flexible grid optical network, and returns a global optimization result to the requesting unit for global optimization 10. In this case, after the requesting unit for global optimization 10 receives a global optimization result, it may send this global optimization result to source/destination LSR (label switching router) to establish every traffic engineer-label switched path (TE-LSP).

The requesting unit for global optimization 10 may be put in the network management system of the flexible grid optical network as a separate module, or be a module integrated in the control protocol stack at every node of the flexible grid optical network.

Further, the constraint condition for global optimization may be carried in the request message for global optimization, or preset in the execution unit for global optimization 20, wherein the constraint condition for global optimization is used to guide the execution unit for global optimization 20 to perform global optimization. Further, the constraint condition for global optimization may include at least one of maximum value for link utilization (used to indicate a set of possible maximum link utilization ratio), minimum value for link utilization (used to indicate a set of possible minimum link utilization ratio), bandwidth limit reserved for each link (it shall not exceed the limit of its physical capacity), maximum hop count (it is the maximum value of hop count that any TE-LSP can own) and exclusion of certain links or nodes (for example, all TE-LSPs are required not to include some specific links or nodes in all paths). Of course, this constraint condition for global optimization may also include whether re-optimization is allowed so as to re-deploy the existing traffic to new TE-LSPs. These constraint conditions for global optimization represent the conditions that shall be met during global optimization. Moreover, the specific values of these constraint conditions for global optimization may be designated in a request message for global optimization or preset in the execution unit for global optimization 20.

Further, the request message for global optimization may also carry types for global optimization (for example: green space planning or defragmentation).

Preferably, that the execution unit for global optimization 20 performs global optimization based on the constraint condition for global optimization, the computation algorithm for global optimization and the network topology and resource information of the flexible grid optical network may include that: the execution unit for global optimization 20 obtains an extreme value of a given non-convex objective function based on the constraint condition for global optimization, the computation algorithm for global optimization and the network topology and resource information of the flexible grid optical network.

Wherein, the extreme value of the non-convex objective function represents the objective value of global optimization. Moreover, basic non-convex objective function may include at least one of minimum aggregated bandwidth consumption, minimum load of a load link, or minimum accumulated cost of a path set.

Preferably, the computation algorithm for global optimization may be a constrained path algorithm, a minimum path algorithm or a K algorithm. As these algorithms are known to those skilled in the art, they are not detailed here. The computation algorithm for global optimization may also be an algorithm integrating a meta-heuristic algorithm and a local search algorithm. The meta-heuristic algorithm is mainly based on some tools whose simulation properties relate to artificial intelligence. The meta-heuristic algorithm mainly focuses on the research and development of search programs to achieve the goal of covering diversified search in all search spaces and enhanced search in some promising fields. Therefore, the meta-heuristic algorithm can't be easily trapped in local minimum value. However, the cost of calculation of meta-heuristic algorithm is expensive because their convergence rates are very low. The convergence rate of this kind of algorithms is low. A very important reason is that they may not detect a promising search direction, particularly near local minimum value—because they will develop randomly. The integration of the meta-heuristic algorithm and the local search algorithm can overcome the defects of meta-heuristic algorithm including low convergence rate and random development. As the meta-heuristic algorithm and the local search algorithm are also known to those skilled in the art, they are not detailed here.

Preferably, when the execution unit for global optimization 20 does not find a feasible global optimization result (for example, no optimized optical path is found when obtaining optical path), the execution unit for global optimization 20 is busy or the execution unit for global optimization 20 does not possess the capability of concurrent re-optimization, the execution unit for global optimization 20 will also send the requesting unit for global optimization 10 a response message indicating no feasible global optimization result is found, or the execution unit for global optimization 20 is busy or the execution unit for global optimization 20 does not possess the capability of concurrent re-optimization.

Further, under the following circumstances, the execution unit for global optimization 20 preferably sends the requesting unit for global optimization 10 a response message to inform these circumstances to the requesting unit for global optimization 10: (1) the memory of the execution unit for global optimization 20 overflows; (2) management privilege limits global re-optimization unallowable; (3) no traffic migration path is available; (4) during traffic migration, it is impossible that the execution unit for global optimization 20 faces all existing TE-LSP paths to execute “make-before break”.

Preferably, the requesting unit for global optimization 10 communicates with the execution unit for global optimization 20 via the Path Computation Element Protocol (PCEP) formulated by RFC5440.

Below the flow of the method for global optimization of a flexible grid optical network according to the present invention is described referring to FIG. 2. It includes:
S11: Receiving and parsing a request message for global optimization;
S12: Performing global optimization based on a constraint condition for global optimization, a computation algorithm for global optimization and a network topology and resource information of the flexible grid optical network, and sending a global optimization result.

Wherein, the constraint condition for global optimization may be carried in the request message for global optimization, or preset. The constraint condition for global optimization is used to guide the execution of global optimization. Further, the constraint condition for global optimization may include at least one of maximum value for link utilization (used to indicate a set of possible maximum link utilization ratio), minimum value for link utilization (used to indicate a set of possible minimum link utilization ratio), bandwidth limit reserved for each link (it shall not exceed the limit of its physical capacity), maximum hop count (it is the maximum value of hop count that any TE-LSP can own) and exclusion of certain links or nodes (for example, all TE-LSPs are required not to include some specific links or nodes in all paths). Of course, this constraint condition for global optimization may also include whether re-optimization is allowed so as to re-deploy the existing traffic to new TE-LSP. These constraint conditions for global optimization represent the conditions that shall be met during global optimization. Moreover, the specific values of these constraint conditions for global optimization may be designated in a request message for global optimization or preset.

Further, the request message for global optimization may also carry types for global optimization (for example: green space planning or defragmentation).

Preferably, performing global optimization based on a constraint condition for global optimization, a computation algorithm for global optimization and a network topology and resource information of the flexible grid optical network may include obtaining an extreme value of a given non-convex objective function based on the constraint condition for global optimization, the computation algorithm for global optimization and the network topology and resource information of the flexible grid optical network.

Wherein, the extreme value of the non-convex objective function represents the objective value of global optimization. Moreover, basic non-convex objective function may include at least one of minimum aggregated bandwidth consumption, minimum load of a load link, or minimum accumulated cost of a path set. This setting aims to find a solution of global optimization.

Preferably, the computation algorithm for global optimization may be a constrained path algorithm, a minimum path algorithm or a K algorithm. As these algorithms are known to those skilled in the art, they are not detailed here. The computation algorithm for global optimization may also be an algorithm integrating a meta-heuristic algorithm and a local search algorithm. The meta-heuristic algorithm is mainly based on some tools whose simulation properties relate to artificial intelligence. The meta-heuristic algorithm mainly focuses on the research and development of search programs to achieve the goal of covering diversified search in all search spaces and enhanced search in some promising fields. Therefore, the meta-heuristic algorithm can't be easily trapped in local minimum value. However, the cost of calculation of meta-heuristic algorithm is expensive because their convergence rates are very low. The convergence rate of this kind of algorithms is low. A very important reason is that they may not detect a promising search direction, particularly near local minimum value—because they will develop randomly. The integration of the meta-heuristic algorithm and the local search algorithm can overcome the defects of the meta-heuristic algorithm including low convergence rate and random development. As the meta-heuristic algorithm and the local search algorithm are also known to those skilled in the art, they are not detailed here.

Preferably, when it does not find a feasible global optimization result, or it is busy or it does not possess the capability of concurrent re-optimization, it will send a response message indicating no feasible global optimization result is found, or it is busy or it does not possess the capability of concurrent re-optimization.

Further, under the following circumstances, preferably a response message is sent to the outside to inform these circumstances: (1) the memory overflows; (2) management privilege limits global re-optimization unallowable; (3) no traffic migration path is available; (4) during traffic migration, it is impossible to face all existing TE-LSP paths to execute “make-before break”.

Above the present invention is described in details in connection with the preferred embodiment of the present invention, but those skilled in the art should understand various changes and modifications may be made to the present invention provided that they do not depart from the spirit or scope of the present invention.

1. A system architecture for global optimization of a flexible grid optical network, comprising a requesting unit for global optimization and an execution unit for global optimization, wherein:
the requesting unit for global optimization generates a request message for global optimization, and sends the request message for global optimization to the execution unit for global optimization;
the execution unit for global optimization parses the request message for global optimization, performs global optimization based on a constraint condition for global optimization, a computation algorithm for global optimization and a network topology and resource information of the flexible grid optical network, and returns a global optimization result to the requesting unit for global optimization.

2. The system architecture according to claim 1, wherein the constraint condition for global optimization is carried in the request message for global optimization, or preset in the execution unit for global optimization.

3. The system architecture according to claim 2, wherein the constraint condition for global optimization includes at least one of maximum value for link utilization, minimum value for link utilization, bandwidth limit reserved for each link, maximum hop count, or exclusion of certain links or nodes.

4. The system architecture according to claim 2, wherein the request message for global optimization also carries types of global optimization.

5. The system architecture according to claim 2, wherein the computation algorithm for global optimization is an algorithm integrating a meta-heuristic algorithm and a local search algorithm.

6. The system architecture according to claim 2, wherein the execution unit for global optimization performs global optimization based on the constraint condition for global optimization, the computation algorithm for global optimization and the network topology and resource information of the flexible grid optical network includes:
the execution unit for global optimization obtains an extreme value of a given non-convex objective function based on the constraint condition for global optimization, the computation algorithm for global optimization and the network topology and resource information of the flexible grid optical network.

7. The system architecture according to claim 6, wherein the non-convex objective function includes at least one of minimum aggregated bandwidth consumption, minimum load of a load link, or minimum accumulated cost of a path set.

8. The system architecture according to claim 1, wherein when the execution unit for global optimization does not find a feasible global optimization result, the execution unit for global optimization is busy or the execution unit for global optimization does not possess capability of concurrent re-optimization, the execution unit for global optimization further sends the requesting unit for global optimization a response message indicating that no feasible global optimization result is found, or the execution unit for global optimization is busy or the execution unit for global optimization does not possess the capability of concurrent re-optimization.

9. The system architecture according to claim 1, wherein the requesting unit for global optimization communicates with the execution unit for global optimization via Path Computation Element Communication Protocol formulated by RFC5440.

10. A method for global optimization of a flexible grid optical network, which includes:
receiving and parsing a request message for global optimization;
performing global optimization based on a constraint condition for global optimization, a computation algorithm for global optimization and a network topology and resource information of the flexible grid optical network, and sending a global optimization result.

11. The method according to claim 10, wherein the constraint condition for global optimization is carried in the request message for global optimization, or preset.

12. The method according to claim 11, wherein the constraint condition for global optimization includes at least one of maximum value for link utilization, minimum value for link utilization, bandwidth limit reserved for each link, maximum hop count, or exclusion of certain links or nodes.

13. The method according to claim 11, wherein the request message for global optimization also carries types for global optimization.

14. The method according to claim 11, wherein the computation algorithm for global optimization is an algorithm integrating a meta-heuristic algorithm and a local search algorithm.

15. The method according to claim 11, wherein performing global optimization based on the constraint condition for global optimization, the computation algorithm for global optimization and the network topology and resource information of the flexible grid optical network includes:
obtaining an extreme value of a given non-convex objective function based on the constraint condition for global optimization, the computation algorithm for global optimization and the network topology and resource information of the flexible grid optical network.

16. The method according to claim 15, wherein the non-convex objective function includes at least one of minimum aggregated bandwidth consumption, minimum load of load link, or minimum accumulated cost of path set.

17. The method according to claim 10, wherein when no feasible global optimization result is found, busy, or capability of concurrent re-optimization is not possessed, sending a response message indicating no feasible global optimization result is found, busy, or the capability of concurrent re-optimization is not possessed.
